(19) United States
(12) Patent Application Publication
(10) Pub. No.: US 2024/0383540 A1
(43) Pub. Date: Nov. 21, 2024

(54) BOTTOM STRUCTURE OF VEHICLE

(71) Applicant: Honda Motor Co., Ltd., Tokyo (JP)

(72) Inventors: Yu IEMURA, Saitama (JP); Ken YASUI, Saitama (JP); Shutaro SAO, Saitama (JP)

(73) Assignee: Honda Motor Co., Ltd., Tokyo (JP)

(21) Appl. No.: 18/637,399

(22) Filed: Apr. 16, 2024

(30) Foreign Application Priority Data
May 16, 2023 (CN) 202310550174.4

(51) Int. Cl. B62D 25/20; B60L 50/60

(52) U.S. Cl. CPC B62D 25/2072; B62D 25/2036; B60L 50/66

(57) ABSTRACT

A bottom structure of a vehicle is capable of preventing a floor cross member from interfering with a battery after being deformed. The bottom structure of the vehicle includes: a floor panel; a battery which is disposed below the floor panel in a vehicle up-down direction; a side sill which is disposed on an outer side of the floor panel in a vehicle width direction and extends along a vehicle front-rear direction; and a floor cross member which is connected to the side sill and extends toward an inner side in the vehicle width direction. The floor cross member includes a fragile portion, and the fragile portion is disposed further outside than the battery in the vehicle width direction and on a lower side of the floor cross member in the vehicle up-down direction.

### CROSS-REFERENCE TO RELATED APPLICATION

This application claims the priority benefit of China application serial no. 202310550174.4, filed on May 16, 2023. The entirety of the above-mentioned patent application is hereby incorporated by reference herein and made a part of this specification.

### BACKGROUND

### Technical Field

The disclosure relates to a bottom structure of a vehicle.

### Description of Related Art

In order to allow the elderly, the disabled, children and other disadvantaged groups to use a sustainable transport system, efforts have been made to provide a transportation vehicle with better vehicle body rigidity. In the existing technology, the battery is disposed below the floor panel of the vehicle, especially below the floor cross member. However, when a vehicle impact causes the floor cross member to deform, the floor cross member may interfere with the battery and cause damage. The disclosure is intended to improve the vehicle body rigidity, and is further expected to provide a sustainable transport system.

### SUMMARY

The disclosure provides a bottom structure of a vehicle capable of preventing a floor cross member from interfering with a battery after being deformed.

The bottom structure of the vehicle of the disclosure includes: a floor panel; a battery which is disposed below the floor panel in a vehicle up-down direction; a side sill which is disposed on an outer side of the floor panel in a vehicle width direction and extends along a vehicle front-rear direction; and a floor cross member which is connected to the side sill and extends toward an inner side in the vehicle width direction. The floor cross member includes a fragile portion, and the fragile portion is disposed further outside than the battery in the vehicle width direction and on a lower side of the floor cross member in the vehicle up-down direction.

In order to make the above-mentioned features and advantages of the disclosure comprehensible, embodiments accompanied with drawings are described in detail as follows.

### BRIEF DESCRIPTION OF THE DRAWINGS

FIG. 1 is a schematic perspective view of a bottom structure of a vehicle according to an embodiment of the disclosure.

FIG. 2 is a front cross-sectional view along a section line A-A of the bottom structure of the vehicle of FIG. 1.

FIG. 3 is a partially enlarged perspective view of the bottom structure of the vehicle of FIG. 1.

FIG. 4 is a partially enlarged perspective view of a bottom structure of a vehicle according to another embodiment of the disclosure.

FIG. 5 is a partially enlarged perspective view of a bottom structure of a vehicle according to another embodiment of the disclosure.

### DESCRIPTION OF THE EMBODIMENTS

In an embodiment of the disclosure, the battery is connected to the side sill through a battery side frame, the battery side frame is disposed on an outer side of the battery in the vehicle width direction, and the battery side frame extends along the vehicle front-rear direction. The fragile portion is formed at a position corresponding to between the battery and the battery side frame in the vehicle width direction.

In an embodiment of the disclosure, the battery is accommodated in a battery pack, and the battery pack is connected to an inner side of the battery side frame in the vehicle width direction. The battery and the battery side frame are disposed apart from each other in the vehicle width direction to form a separation portion, and the fragile portion is formed on a center side corresponding to the separation portion in the vehicle width direction.

In an embodiment of the disclosure, the floor cross member further includes: a side wall which includes a side surface and a flange portion connected to the floor panel; and an upper wall which is connected to an upper end of the side surface in the vehicle up-down direction and includes a ridge portion extending along the vehicle width direction. The fragile portion is formed on a lower side of the side wall in the vehicle up-down direction, and an outer end portion of the ridge portion in the vehicle width direction extends along the vehicle width direction to a position further outside than the battery and further inside than an outer end portion of the fragile portion in the vehicle width direction.

In an embodiment of the disclosure, at least a part of the ridge portion corresponds to the fragile portion in the vehicle up-down direction when viewed from the vehicle front-rear direction.

In an embodiment of the disclosure, the side surface of the side wall includes a narrow portion, and the fragile portion is formed on a lower side of the narrow portion in the vehicle up-down direction.

In an embodiment of the disclosure, the fragile portion is a convex portion formed on the flange portion of the side wall and protruding upward in the vehicle up-down direction, and the convex portion extends along the vehicle front-rear direction.

In an embodiment of the disclosure, the fragile portion is a cutout formed in at least one of the side surface or the flange portion.

In an embodiment of the disclosure, the upper wall of the floor cross member further includes a reinforcing member formed on a lower surface of the upper wall, and the reinforcing member is disposed at a position further outside than the fragile portion in the vehicle width direction and corresponding to the battery side frame.

In an embodiment of the disclosure, the floor cross member is connected to a floor frame extending along the vehicle front-rear direction, and the fragile portion is disposed parallel to the floor frame in the vehicle front-rear direction.

Based on the above, in the bottom structure of the vehicle of the disclosure, the floor cross member is provided with the fragile portion located further outside than the battery in the vehicle width direction and below the floor cross member. In this way, when a side impact occurs, the fragile portion is easily deformed to ensure that the floor cross member is deformed outside and above the battery, and does not deform around the battery and interfere with the battery. In addition, the deformation of the fragile portion can absorb more impact force, thereby reducing the damage suffered. Accordingly, the bottom structure of the vehicle of the disclosure can prevent the floor cross member from interfering with the battery after being deformed.

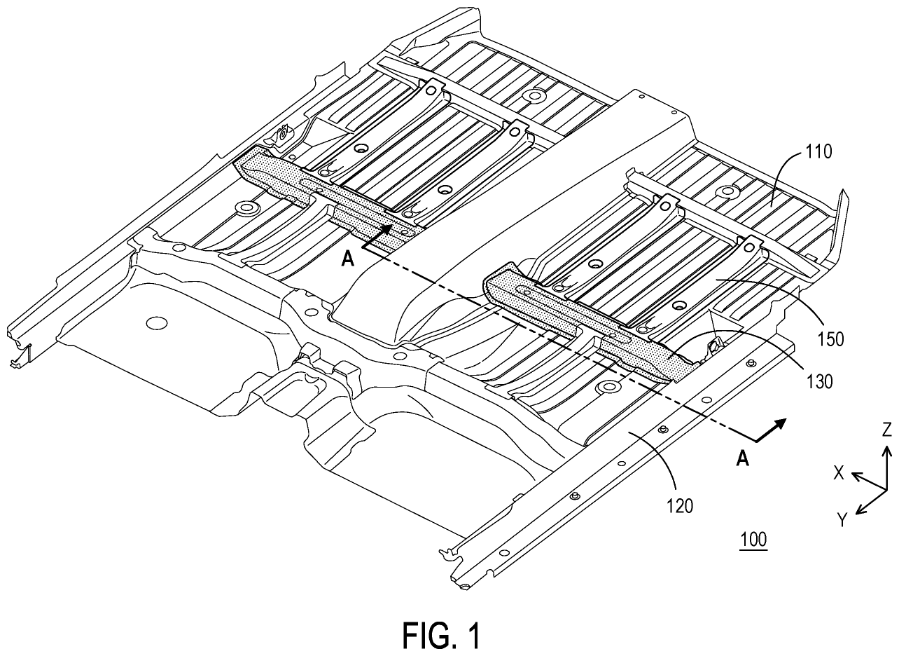

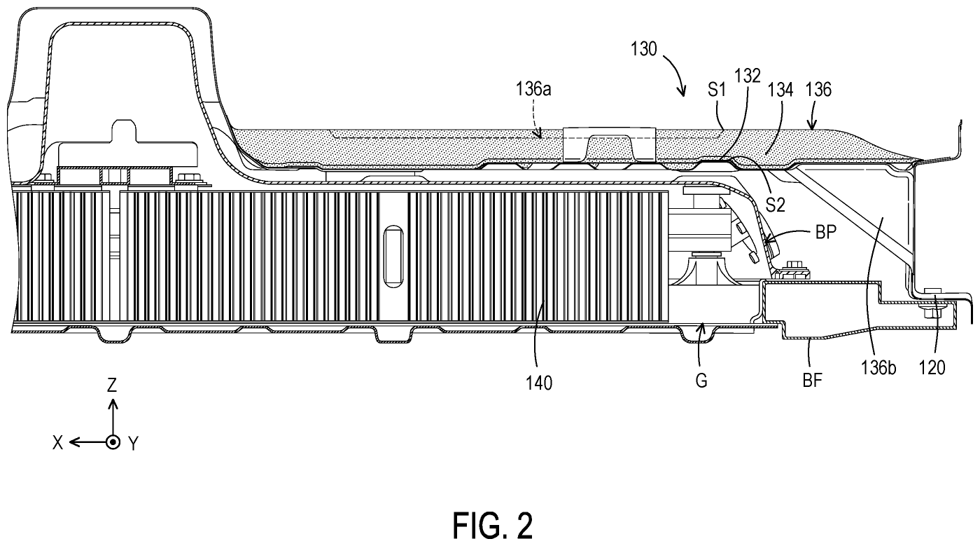

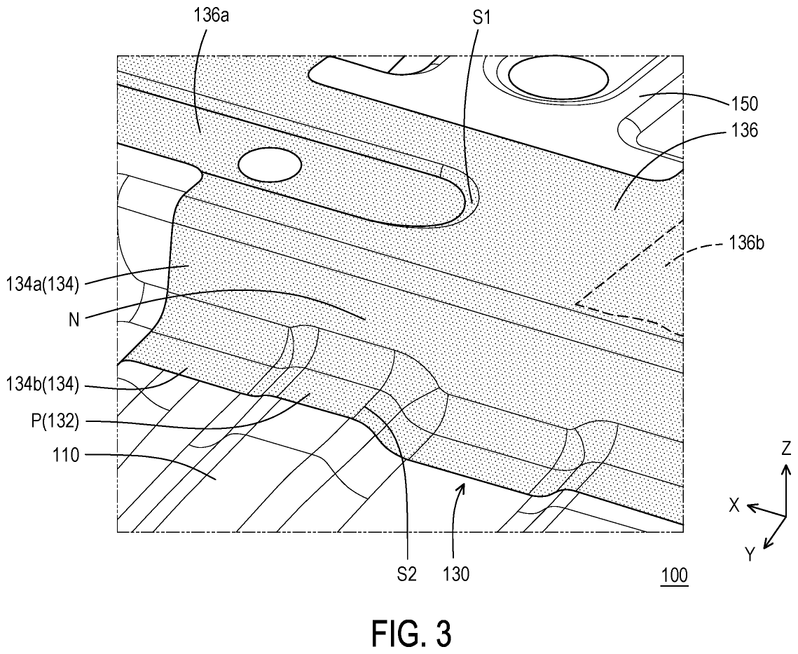

FIG. 1 is a schematic perspective view of a bottom structure of a vehicle according to an embodiment of the disclosure. FIG. 2 is a front cross-sectional view along a section line A-A of the bottom structure of the vehicle of FIG. 1. FIG. 3 is a partially enlarged perspective view of the bottom structure of the vehicle of FIG. 1. In the embodiment, a bottom structure of a vehicle 100 is, for example, the bottom structure of an ordinary passenger car (not shown), but may also be applied to any other similar device, and is not limited by the disclosure. A vehicle width direction X, a vehicle front-rear direction Y, and a vehicle up-down direction Z in the drawings are not intended to limit the positional relationship of each component in the disclosure. In addition, it should be noted that, unless otherwise specified, the front and above used in the following description are the directions pointed by arrows of the vehicle front-rear direction Y and the vehicle up-down direction Z, and the rear and below used in the description are the opposite directions of the aforementioned. An inner side and an outer side used in the description are relative positions in the vehicle width direction X. The direction pointed by the arrow of the vehicle width direction X is not used to limit the inner side or the outer side. Wherever possible, the same reference numerals are used in the accompanying drawings and descriptions to refer to the same or similar parts. The bottom structure of the vehicle 100 of the embodiment will be described below with reference to FIGS. 1 to 3.

Referring to FIGS. 1 and 2, in the embodiment, the bottom structure of the vehicle 100 includes a floor panel 110, a side sill 120, a floor cross member 130 and a battery 140. The side sill 120 is disposed on an outer side of the floor panel 110 in the vehicle width direction X and extends along the vehicle front-rear direction Y. The floor cross member 130 is connected to the side sill 120 and extends toward an inner side in the vehicle width direction X. The battery 140 is disposed below the floor panel 110 in the vehicle up-down direction Z (as shown in FIG. 2). Furthermore, the floor cross member 130 shown in FIG. 2 is disposed above the battery 140 in the vehicle up-down direction Z, and extends further outside than the battery 140 along the vehicle width direction X. The floor cross member 130 includes a fragile portion 132 that is easily deformed. The fragile portion 132 is disposed further outside than the battery 140 in the vehicle width direction X and on a lower side of the floor cross member 130 in the vehicle up-down direction Z. Therefore, the floor cross member 130 uses the fragile portion 132 as a bending boundary point to form a holding area further inside than the fragile portion 132 in the vehicle width direction X and a deformation area further outside than the fragile portion 132 in the vehicle width direction X. The fragile portion 132 is, for example, a protruding portion (a convex portion P described later) on the edge of the floor cross member 130. However, in other embodiments not shown, the fragile portion 132 may also be other structures or devices that easily deform the floor cross member 130, and the disclosure is not limited thereto.

It can be seen from this that in the bottom structure of the vehicle 100 of the embodiment, the floor cross member 130 is provided with the fragile portion 132 located further outside than the battery 140 in the vehicle width direction X and below the floor cross member 130. In this way, when a side impact occurs, the fragile portion 132 is easily deformed to ensure that the floor cross member 130 is deformed outside and above the battery 140 and does not deform around the battery 140 and interfere with the battery 140. In addition, the deformation of the fragile portion 132 can absorb more impact force, thereby reducing the damage suffered. Accordingly, the bottom structure of the vehicle 100 of the embodiment can prevent the floor cross member 130 from interfering with the battery 140 after being deformed.

Referring to FIG. 2, in the embodiment, the battery 140 is connected to the side sill 120 in the vehicle width direction X through a battery side frame BF. For example, the battery side frame BF is disposed on an outer side of the battery 140 in the vehicle width direction X and extends along the vehicle front-rear direction Y. The battery side frame BF is formed by a relatively rigid material, but the disclosure is not limited thereto. The fragile portion 132 is formed at a position corresponding to between the battery 140 and the battery side frame BF in the vehicle width direction X. In other words, when viewed from the vehicle front-rear direction Y (i.e., the perspective of FIG. 2), the fragile portion 132 is disposed between an outer end portion of the battery 140 and an inner end portion of the battery side frame BF in the vehicle width direction X. Therefore, the fragile portion 132 is easily deformed due to the rigidity difference between the fragile portion 132 and the battery side frame BF, thereby suppressing the floor cross member 130 from deforming toward the battery 140 side and absorbing the impact force.

In an exemplary example, in the embodiment, the battery 140 is accommodated in a battery pack BP, and the battery pack BP is connected to the inner end portion of the battery side frame BF in the vehicle width direction X. In particular, the battery 140 and the battery side frame BF are disposed apart from each other in the vehicle width direction X to form a separation portion G, and the fragile portion 132 is formed on a center side corresponding to the separation portion G in the vehicle width direction X. That is, when viewed from the vehicle front-rear direction Y (i.e., the perspective of FIG. 2), the fragile portion 132 is disposed above the center position of the separation portion G in the vehicle width direction X and above the vehicle up-down direction Z. Therefore, the fragile portion 132 may be easily deformed, and a large deformation space of the floor cross member 130 may be ensured, thereby suppressing the floor cross member 130 from deforming toward the battery 140 side and absorbing the impact force.

Referring to FIGS. 2 and 3, in the embodiment, the floor cross member 130 further includes a side wall 134 and an upper wall 136. As shown in FIG. 3, the side wall 134 includes a side surface 134a and a flange portion 134b. The side surface 134a extends along the vehicle up-down direction Z, and the flange portion 134b is formed on a lower side of the side surface 134a in the vehicle up-down direction Z. The flange portion 134b extends along the vehicle front-rear direction Y and is connected to the floor panel 110 in the vehicle up-down direction Z. The upper wall 136 is connected to an upper end of the side surface 134a in the vehicle up-down direction Z, and includes a ridge portion 136a extending along the vehicle width direction X. In particular, the fragile portion 132 is formed on a lower side of the side wall 134 in the vehicle up-down direction Z, that is, on the flange portion 134b. Furthermore, an outer end portion S1 of the ridge portion 136a in the vehicle width direction X extends along the vehicle width direction X to a position further outside than the battery 140 and further inside than an outer end portion S2 of the fragile portion 132 in the vehicle width direction X. In an exemplary example, at least a part of the ridge portion 136a corresponds to the fragile portion 132 in the vehicle up-down direction Z when viewed from the vehicle front-rear direction Y (i.e., the perspective of FIG. 2). Therefore, the fragile portion 132 is easily deformed due to the difference in rigidity between the fragile portion 132 and the ridge portion 136a. In addition, the fragile portion 132 is disposed on the lower side so that the lower portion of the floor cross member 130 is deformed, thereby bending above where the fragile portion 132 is located to prevent the floor cross member 130 from contacting the battery 140.

In addition, as shown in FIG. 3, in the embodiment, the side surface 134a of the side wall 134 includes a narrow portion N with a smaller area. The width of the narrow portion N in the vehicle up-down direction Z is, for example, narrower than the width of the other side surfaces 134a in the vehicle up-down direction Z. However, in other not shown embodiments, the width in other directions may also be narrower, and the disclosure is not limited thereto. The fragile portion 132 is formed on a lower side of the narrow portion N in the vehicle up-down direction Z. Furthermore, the fragile portion 132 is the convex portion P formed on the flange portion 134b of the side wall 134 and protruding upward in the vehicle up-down direction Z, and the convex portion P extends along the vehicle front-rear direction Y. Such a configuration may further ensure that the lower portion of the floor cross member 130 is deformed, thereby bending above the fragile portion 132 to suppress the floor cross member 130 from deforming toward the battery 140 side.

Furthermore, in the embodiment, the floor cross member 130 is connected to a floor frame 150 extending in the vehicle front-rear direction Y. For example, multiple floor frames 150 are disposed (as shown in FIG. 1), but the number may be adjusted according to actual needs, and the disclosure is not limited thereto. In particular, the fragile portion 132 is disposed parallel to the floor frame 150 in the vehicle front-rear direction Y. In this way, in addition to further ensuring the rigidity of the vehicle in the front-rear direction Y, when a side impact occurs, the connection between the floor cross member 130 and the floor frame 150 is easily bent, and the impact force may be further absorbed.

Furthermore, in the embodiment, the upper wall 136 of the floor cross member 130 further includes a reinforcing member 136b. The reinforcing member 136b is formed on a lower surface of the upper wall 136. The reinforcing member 136b is disposed at a position further outside than the fragile portion 132 in the vehicle width direction X and corresponding to the battery side frame BF. Specifically, the reinforcing member 136b is formed to extend obliquely from the upper wall 136 toward the outer side in the vehicle width direction X and downward in the vehicle up-down direction Z, and is connected to the side sill 120. The reinforcing member 136b is located approximately above the battery side frame BF in the vehicle up-down direction Z. Therefore, a difference in rigidity is formed between the fragile portion 132 of the floor cross member 130 and the portion of the floor cross member 130 located further outside, so that deformation occurs easily in the fragile portion 132.

In other embodiments, the fragile portion may also be a cutout formed in at least one of the side surface 134a or the flange portion 134b. The following describes different fragile portion structures.

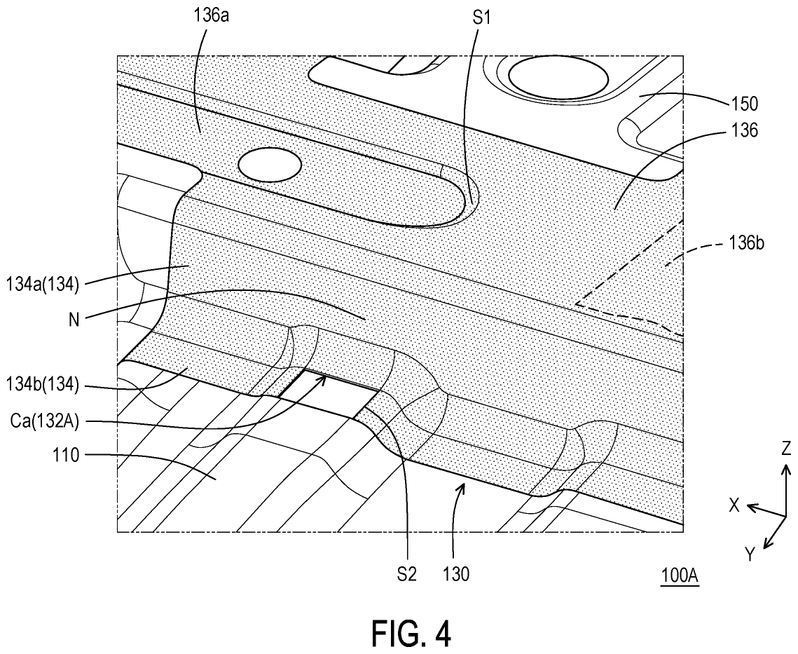

FIG. 4 is a partially enlarged perspective view of a bottom structure of a vehicle according to another embodiment of the disclosure. The difference between a bottom structure of a vehicle 100A and the bottom structure of the vehicle 100 is a fragile portion 132A. In the embodiment, the fragile portion 132A is a cutout Ca formed in the flange portion 134b.

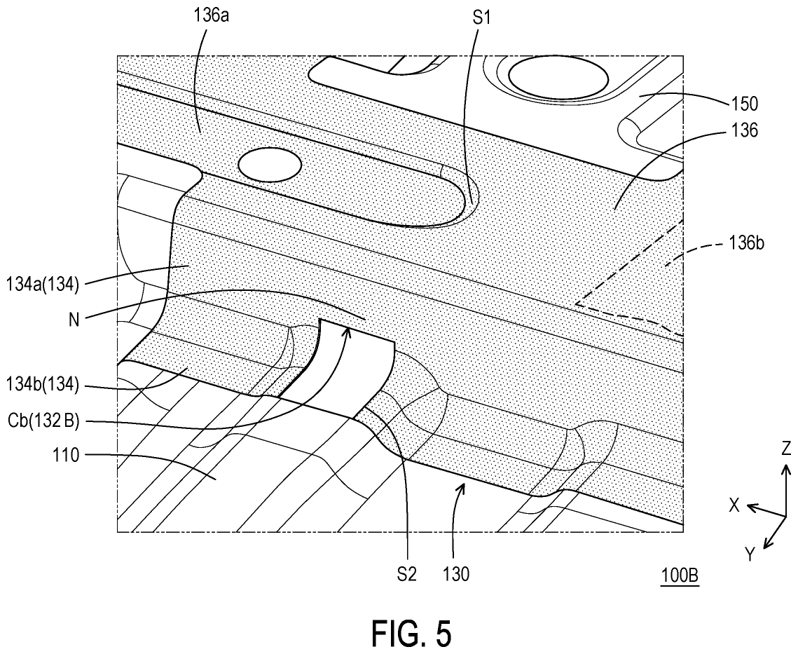

FIG. 5 is a partially enlarged perspective view of a bottom structure of a vehicle according to another embodiment of the disclosure. The difference between a bottom structure of a vehicle 100B and the bottom structure of the vehicle 100A is a fragile portion 132B. In the embodiment, the fragile portion 132B is a cutout Cb formed in the side surface 134a and the flange portion 134b. That is, the fragile portion 132B is formed as a larger cutout than the fragile portion 132A.

To sum up, in the bottom structure of the vehicle of the disclosure, the floor cross member is provided with the fragile portion located further outside than the battery in the vehicle width direction and below the floor cross member. In this way, when a side impact occurs, the fragile portion is easily deformed to ensure that the floor cross member is deformed outside and above the battery, and does not deform around the battery and interfere with the battery. In addition, the deformation of the fragile portion can absorb more impact force, thereby reducing the damage suffered. Furthermore, the fragile portion is formed at a position corresponding to between the battery and the battery side frame in the vehicle width direction. As a result, the fragile portion is easily deformed due to the difference in rigidity between the fragile portion and the battery side frame. Accordingly, the bottom structure of the vehicle of the disclosure can suppress the floor cross member from interfering with the battery after being deformed.

Finally, it should be noted that the above embodiments are merely used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

What is claimed is:

1. A bottom structure of a vehicle, comprising:
a floor panel;
a battery, disposed below the floor panel in a vehicle up-down direction;
a side sill, disposed on an outer side of the floor panel in a vehicle width direction and extending along a vehicle front-rear direction; and
a floor cross member, connected to the side sill and extending toward an inner side in the vehicle width direction, wherein
the floor cross member comprises a fragile portion, and the fragile portion is disposed further outside than the battery in the vehicle width direction and on a lower side of the floor cross member in the vehicle up-down direction.

2. The bottom structure of the vehicle according to claim 1, wherein
the battery is connected to the side sill through a battery side frame, the battery side frame is disposed on an outer side of the battery in the vehicle width direction, and the battery side frame extends along the vehicle front-rear direction, and
the fragile portion is formed at a position corresponding to between the battery and the battery side frame in the vehicle width direction.

3. The bottom structure of the vehicle according to claim 2, wherein
the battery is accommodated in a battery pack, and the battery pack is connected to an inner side of the battery side frame in the vehicle width direction,
the battery and the battery side frame are disposed apart from each other in the vehicle width direction to form a separation portion, and
the fragile portion is formed on a center side corresponding to the separation portion in the vehicle width direction.

4. The bottom structure of the vehicle according to claim 2, wherein the floor cross member further comprises:
a side wall, comprising a side surface and a flange portion connected to the floor panel; and
an upper wall, connected to an upper end of the side surface in the vehicle up-down direction, and comprising a ridge portion extending along the vehicle width direction, wherein
the fragile portion is formed on a lower side of the side wall in the vehicle up-down direction, and
an outer end portion of the ridge portion in the vehicle width direction extends along the vehicle width direction to a position further outside than the battery and further inside than an outer end portion of the fragile portion in the vehicle width direction.

5. The bottom structure of the vehicle according to claim 4, wherein
at least a part of the ridge portion corresponds to the fragile portion in the vehicle up-down direction when viewed from the vehicle front-rear direction.

6. The bottom structure of the vehicle according to claim 4, wherein
the side surface of the side wall comprises a narrow portion, and
the fragile portion is formed on a lower side of the narrow portion in the vehicle up-down direction.

7. The bottom structure of the vehicle according to claim 4, wherein
the fragile portion is a convex portion formed on the flange portion of the side wall and protruding upward in the vehicle up-down direction, and the convex portion extends along the vehicle front-rear direction.

8. The bottom structure of the vehicle according to claim 4, wherein
the fragile portion is a cutout formed in at least one of the side surface or the flange portion.

9. The bottom structure of the vehicle according to claim 4, wherein
the upper wall of the floor cross member further comprises a reinforcing member formed on a lower surface of the upper wall, and
the reinforcing member is disposed at a position further outside than the fragile portion in the vehicle width direction and corresponding to the battery side frame.

10. The bottom structure of the vehicle according to claim 1, wherein
the floor cross member is connected to a floor frame extending along the vehicle front-rear direction, and
the fragile portion is disposed parallel to the floor frame in the vehicle front-rear direction.
